(19) United States
(12) Patent Application Publication
(10) Pub. No.: US 2008/0036714 A1
(43) Pub. Date: Feb. 14, 2008

(54) Display Control Device, Display Apparatus, Method of Controlling Display Device, Display Control Program, and Storage Medium Storing the Program

(75) Inventors: Akira Imai, Nara (JP); Tomoo Takatani, Nara (JP); Koji Yabuta, Nara (JP); Hiroshi Fukushima, Nara (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 11/574,371

(22) PCT Filed: Aug. 29, 2005
(86) PCT No.: PCT/JP05/15680

§ 371 Date: Feb. 27, 2007

(30) Foreign Application Priority Data
Aug. 30, 2004 (JP) 2004-251073

(51) Int. Cl. G09G 3/36

(52) U.S. Cl. 345/87

(57) ABSTRACT

A control section of a portable phone controls a display on a main display section with a viewing angle that is variable. The control section includes: a viewing-angle obtaining section to obtain viewing-angle information about the viewing-angle of the main display section; and a viewing-angle display control section to control an image display section of the main display section to display the viewing-angle information obtained by the viewing-angle obtaining section. The viewing-angle information is obtainable from a viewing-angle control section. The viewing-angle control section controls a viewing-angle changing section. The viewing-angle changing section changes the viewing angle. It is possible to obtain the viewing-angle information as a result that an operation section conducts an operation to change the viewing angle, and/or as a result that an application executing section executes a predetermined application. The foregoing allows a user to find out a viewing-angle state of the display device by looking at a display screen of the display device from the front.

### BACKGROUND OF THE INVENTION

1. Field of the Invention

The present invention relates to a display control device for controlling a display of a display device with a viewing angle that is variable, a display apparatus, a method of controlling a display device, a display control program, and a storage medium storing the program.

2. Description of the Related Art

Conventionally, liquid crystal displays (LCD) have been widely employed as display devices of portable devices such as portable phones and PDAs (Personal Digital Assistant). Having narrow viewing angles, LCDs have been considered to be disadvantageous compared with CRTs (Cathode Ray Tube) and plasma displays, but recent advancement in LCD technologies has allowed widening of the viewing angles.

However, there is a possibility that, when the portable devices are used in crowded situations in trains, buses, and the like, people around the portable devices peek at what is displayed on a display screen of the portable devices. Especially in creating or reading an electronic mail, it is undesirable in view of privacy that details of the electronic mail are peeked by people around the portable devices.

In response to this problem, there has been suggested an LCD that allows controlling a viewing angle (see Patent Documents 1 to 4, for example). Generally, such LCDs are switchable, from one to the other, between a normal wide viewing-angle mode and a narrow viewing-angle mode, in which the viewing angle is narrow. The narrow viewing-angle mode is a mode in which a displayed image is visible in a normal way from the direct front of the display screen where the user is, and a plain image or a different image is visible from a sideward direction.

For example, in the viewing-angle variable device of Patent Document 1 (Japanese Unexamined Patent Publication No. 105958/1997 (Tokukaihei 9-105958) (publication date: Apr. 22, 1997)), a liquid crystal layer between a pair of substrates becomes a narrow viewing-angle when liquid crystal molecules are aligned vertically to the substrates, while the layer becomes a wide viewing-angle when the molecules are aligned parallel to the substrates. Further, in the portable terminal device of Patent Document 2 (Japanese Unexamined Patent Publication No. 62094/2004 (publication date: Feb. 26, 2004)), the viewing angle of the information displaying means is changed by changing an alignment of liquid crystal between two glass plates.

Further, there has also been a display apparatus divided into several sections, each of which is differentiated from one another in alignment direction and the like, whereby, during the narrow viewing-angle mode, an image different from what is displayed on a display screen is visible when the display screen is seen from a direction other than the front. For example, Patent Document 3 (Japanese Unexamined Patent Publication No. 264768/2001 (publication date: Sep. 26, 2001)) teaches a liquid crystal display apparatus in which alignment layers sandwiching a liquid crystal layer are divided into a plurality of areas, each of which is differentiated in alignment direction from its adjacent areas. Further, Patent Document 4 (Japanese Unexamined Patent Publication No. 38035/2004 (publication date: Feb. 5, 2004)) teaches a liquid crystal display apparatus in which a first liquid crystal cell and a second liquid crystal cell are alternately disposed, and the first liquid crystal cell and the second liquid crystal cell are different in viewing-angle direction from each other.

Furthermore, in the portable terminal device of Patent Document 2, the viewing angle is controlled on the basis of a type of an application being executed. This makes it possible to change the viewing angle automatically on the basis of a situation of use.

As the foregoing discusses, a displayed image is visible in a normal way in both the wide viewing-angle mode and the narrow viewing-angle mode, when it is seen from the direct front of the display screen where a user is. Thus, it is difficult to find out whether or not the viewing angle has been changed. This makes the user feel unsure whether or not the viewing angle is really controlled and privacy is really secured. Especially in the case of the portable terminal device of Patent Document 2 in which the viewing angle is to be changed automatically on the basis of an application, the user does not change the viewing angle voluntarily. This increases the unsureness.

It is possible for the user to find out the viewing-angle state by looking at the display screen sideward if he/she moves himself/herself or tilts the display screen. In this case, however, the user comes sideward to the display screen. This raises a possibility that someone else comes in the direct front of the display screen. This causes the control of the viewing angle to become meaningless.

### SUMMARY OF THE INVENTION

The present invention is in view of the above problems, and has as an object to provide a display control device, a display apparatus, a method of controlling a display device, a display control program, and a storage medium storing the program, for allowing a user to find out a viewing-angle state by looking at a display screen of the display device from the front.

To solve the above problems, a display control device according to the present invention, which device controls a display on a display device with a viewing angle that is variable, includes: a viewing-angle obtaining section to obtain viewing-angle information relating to the viewing angle of the display device; and a viewing-angle display control section to control the display device to display the viewing-angle information obtained by the viewing-angle obtaining section.

A method according to the present invention for controlling a display on a display device with a viewing angle that is variable includes the steps of: obtaining viewing-angle information relating to the viewing angle of the display device; and controlling the display device to display the viewing-angle information.

The viewing-angle information may be an actual value of the viewing angle, or information indicating a level of the viewing angle, e.g. the viewing angle is wide or narrow. Further, it is possible to select any display style in displaying the viewing-angle information, including: displaying by use of a series of characters; displaying by use of an icon; displaying at an upper end section, a lower end section, or a corner section of the display screen; displaying at a central section of the display screen in such a way as to superimpose with other images; and displaying by use of a moving image.

In the above configuration, the viewing-angle information relating to the display device, which information is obtained by the viewing-angle obtaining section, is displayed on the display device as a result of controlling by the viewing-angle display control section.

This allows a user to find out the viewing-angle state by looking at the display screen of the display device from the front. This gives ease to the user in conducting a process relating to privacy, such as creating and seeing an electronic mail. Further, the user no longer needs to move himself/herself or tilt the display screen in order to find out the viewing-angle state.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram showing a schematic structure of a control section and a main display section of a portable phone, according to an embodiment of the present invention.

FIG. 2 is a front view showing an exterior of the portable phone that is opened.

FIG. 3 is a drawing showing display screens that are visible from the front or sideward directions, when the portable phone is set in a wide viewing-angle mode.

FIG. 4 is a drawing showing display screens that are visible from the front or sideward directions, when the portable phone is set in a narrow viewing-angle mode.

FIG. 5 is a block diagram showing a schematic structure of the portable phone.

FIG. 6 is a flowchart showing a flow in a process, performed in the control section, of displaying viewing-angle information.

FIG. 7(a) is a front view of an exemplary display screen, in a wide viewing-angle mode, on which the viewing-angle information is displayed by use of a series of characters.

FIG. 7(b) is a front view of an exemplary display screen, in a narrow viewing-angle mode, on which the viewing-angle information is displayed by use of a series of characters.

FIG. 8(a) is a front view of an exemplary display screen, in the wide viewing-angle mode, on which the viewing-angle information is displayed by use of an icon.

FIG. 8(b) is a front view of an exemplary display screen, in the narrow viewing-angle mode, on which the viewing-angle information is displayed by use of an icon.

FIG. 9(a) is a front view of an exemplary display screen in the wide viewing-angle mode, in a case where the viewing-angle information is to be displayed by use of a series of characters only in the narrow viewing-angle mode.

FIG. 9(b) is a front view of an exemplary display screen in the narrow viewing-angle mode, in the case where the viewing-angle information is to be displayed by use of the series of characters only in the narrow viewing-angle mode.

FIG. 10(a) is a front view of an exemplary display screen in the wide viewing-angle mode, in a case where the viewing-angle information is to be displayed by use of an icon only in the narrow viewing-angle mode.

FIG. 10(b) is a front view of an exemplary display screen in the narrow viewing-angle mode, in the case where the viewing-angle information is to be displayed by use of the icon only in the narrow viewing-angle mode.

FIG. 11(a) is a front view of an exemplary display screen in the wide viewing-angle mode, in a case where the viewing-angle information is to be displayed by use of the series of characters only in the wide viewing-angle mode.

FIG. 11(b) is a front view of an exemplary display screen in the narrow viewing-angle mode, in the case where the viewing-angle information is to be displayed by use of the series of characters only in the wide viewing-angle mode.

FIG. 12(a) is a front view of an exemplary display screen in the wide viewing-angle mode, in a case where the viewing-angle information is to be displayed by use of an icon only in the wide viewing-angle mode.

FIG. 12(b) is a front view of an exemplary display screen in the narrow viewing-angle mode, in the case where the viewing-angle information is to be displayed by use of the icon only in the wide viewing-angle mode.

FIG. 13(a) is a drawing showing a state in which the viewing-angle information is displayed by use of an icon of a moving image, showing the moving image displayed in a manner such that a sector gradually opens.

FIG. 13(b) is a drawing showing a state in which the viewing-angle information is displayed by use of an icon of a moving image, showing the moving image displayed in a manner such that a sector gradually closes.

FIG. 14(a) is a drawing showing another icon as exemplary viewing-angle information, showing how the icon is displayed in the wide viewing-angle mode.

FIG. 14(b) is a drawing showing another icon as exemplary viewing-angle information, showing how the icon is displayed in an intermediate viewing-angle mode.

FIG. 14(c) is a drawing showing another icon as exemplary viewing-angle information, showing how the icon is displayed in the narrow viewing-angle mode.

FIG. 15(a) is a drawing showing another icon as exemplary viewing-angle information, showing how the icon is displayed in the wide viewing-angle mode.

FIG. 15(b) is a drawing showing another icon as exemplary viewing-angle information, showing how the icon is displayed in the narrow viewing-angle mode.

### DETAILED DESCRIPTION OF THE PREFERRED EMBODIMENTS

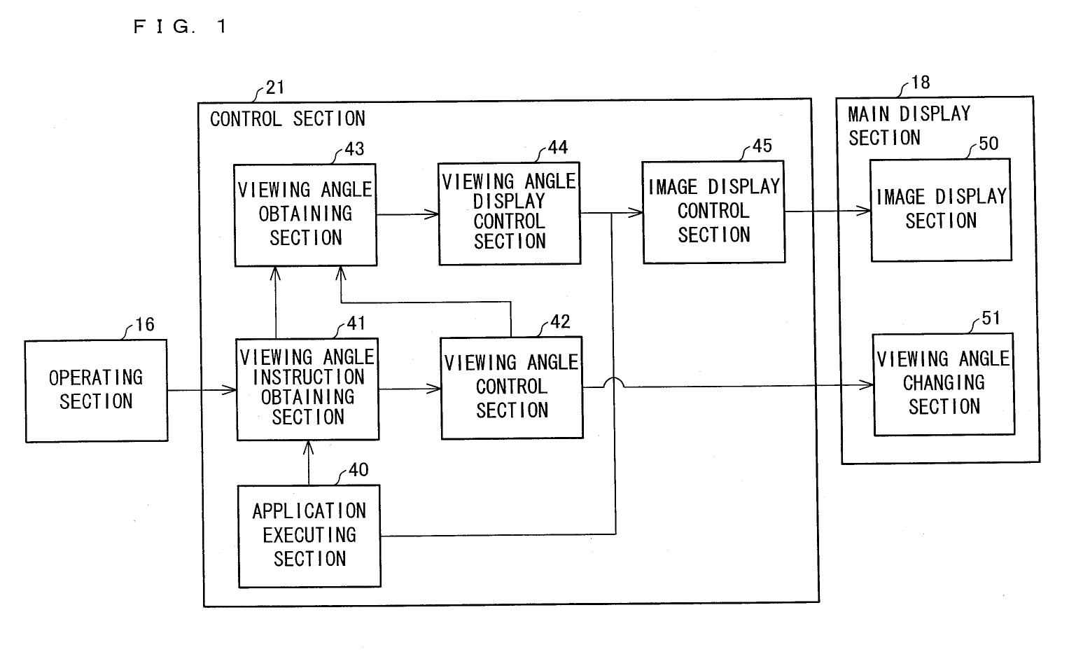

The following discusses an embodiment of the present invention, with reference to FIGS. 1 to 13.

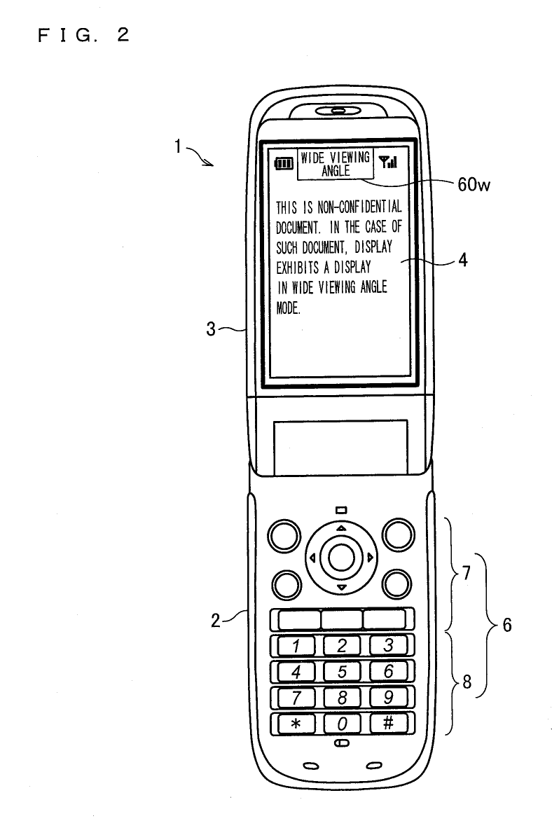

FIG. 2 shows an exterior of a portable phone (display apparatus) 1 according to an embodiment of the present invention. The portable phone 1 of the present embodiment is so-called clamshell type. The portable phone 1 being opened is shown in the figure. The figure shows a section of the portable phone 1, which section becomes the inside when the portable phone 1 is closed. This section is a section to be used mainly by a user when the portable phone 1 is opened. Accordingly, the section shown in the figure will be referred to as a front-surface side in the present application.

As shown in FIG. 2, the portable phone 1 includes a main body 2 and a cover 3. The main body 2 and the cover 3 are coupled together with a hinge. The cover 3 is provided with a main screen 4 on the front-surface side. Note that, although not shown in the figure, a sub screen is provided on a rear-surface side of the portable phone 1, and an antenna is provided in the cover 3.

The main body 2 is provided with main operation buttons 6 on the front-surface side. The main operation buttons 6 includes: function buttons 7 for doing various settings and switching functions of the portable phone 1; and input buttons 8 for inputting symbols such as numbers and characters. Specifically, the function buttons 7 include: a power button for switching ON/OFF a power source of the portable phone; a camera button for starting up a camera mode; a mail button for starting up a mail mode; a cross button for moving a selected object upward, downward, leftward, and/or rightward; an enter button, disposed at a center of the cross button, for entering various selections; and the like. The input buttons 8 are ten-keys.

The portable phone 1 of the present embodiment has a function of controlling a viewing angle of the main screen 4 so as to switch, from one to the other, a wide viewing-angle mode and a narrow viewing-angle mode. It is possible for a user to voluntarily change a setting of the wide viewing-angle mode and the narrow viewing-angle mode by use of the operation buttons. It is also possible to link this setting with application software (the application software will be referred to as “application” hereinafter), such as electronic-mail software, so as to allow the setting to be changed automatically. A variety of configurations for changing the viewing angle have been known. For example Patent Documents 1, 3, and 4 teach such configurations. Thus, description thereof is omitted.

Further, as shown in FIG. 2, the main screen 4 in the portable phone 1 of the present embodiment displays viewing-angle information 60, which indicates a viewing-angle state. This allows a user to easily find out the viewing-angle state by simply looking at the main screen 4 from the front. This gives ease to the user in conducting a process relating to privacy, such as creating and seeing an electronic mail. Further, the user no longer needs to move himself/herself or tilt the main screen 4 in order to find out the viewing-angle state.

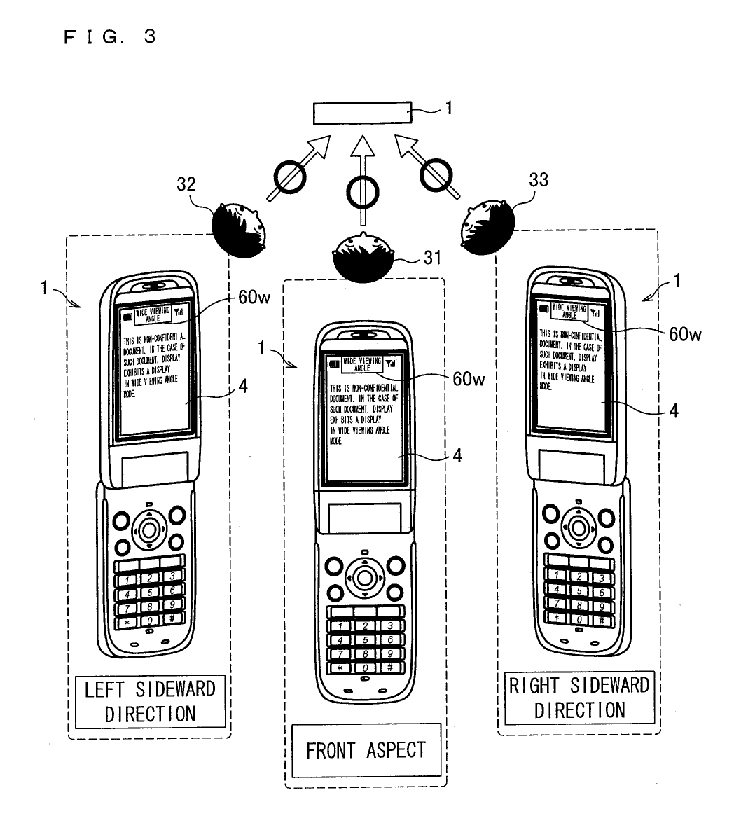

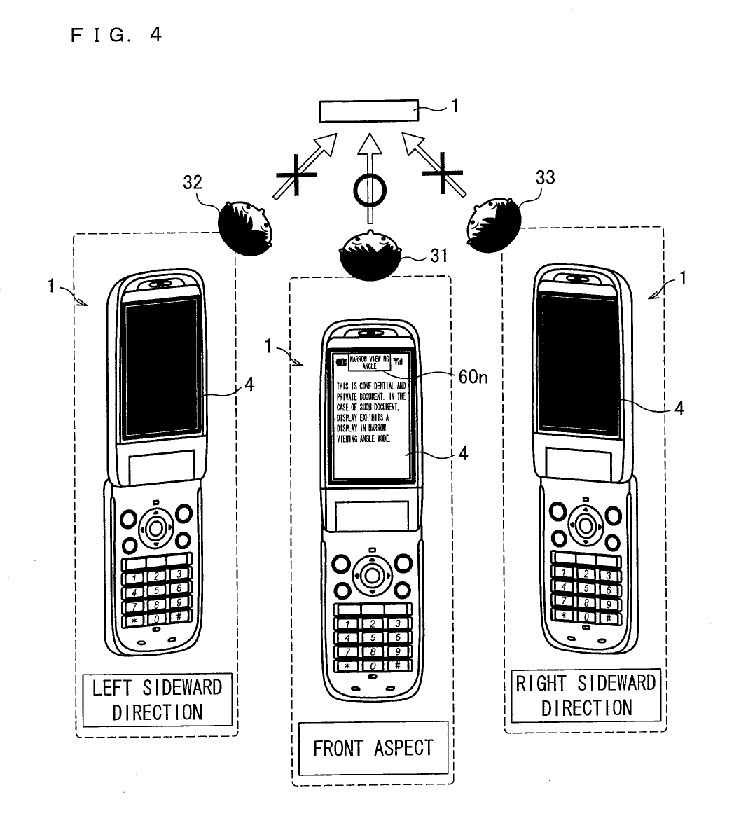

FIG. 3 shows an image to be seen by a person 31, who is in front of the main screen 4, and an image to be seen by persons 32 and 33, who are in sideward directions of the main screen 4, in the case where the wide viewing-angle mode is set. FIG. 4 shows an image to be seen by the person 31, who is in front of the main screen 4, and an image to be seen by the persons 32 and 33, who are in the sideward directions of the main screen 4, in the case where the narrow viewing-angle mode is set.

As shown in FIG. 3, during the wide viewing-angle mode, the image on the main screen 4 is visible when the main screen 4 is seen from the direct front (front direction), from a sideward front on a right-hand side with respect to the main screen 4 (right sideward direction), or from a sideward front on a left-hand side with respect to the main screen 4 (left sideward direction). At this time, viewing-angle information 60w, which indicates a wide viewing angle, is displayed on the main screen 4.

On the other hand, during the narrow viewing-angle mode, as shown in FIG. 4, the image on the main screen 4 is visible from the front direction but invisible from the right sideward direction or the left sideward direction. From the right sideward direction or the left sideward direction, merely a display in black or a different image is visible. At this time, viewing-angle information 60n, which indicates a narrow viewing angle, is displayed on the main screen 4.

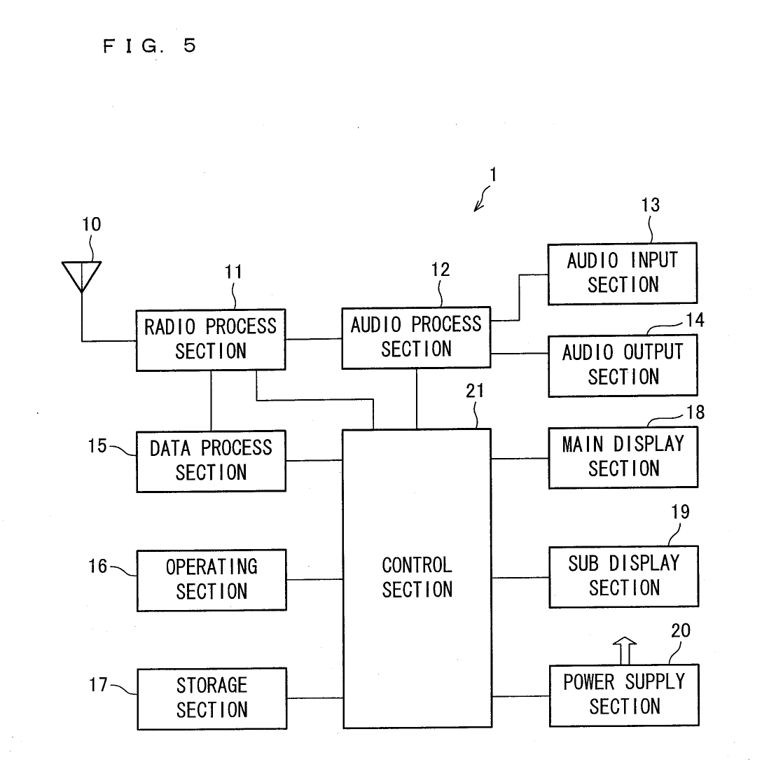

The following discusses a detailed structure of the portable phone 1, with reference to FIGS. 1 and 5. FIG. 5 shows a schematic structure of the portable phone 1. The portable phone 1 includes an antenna section 10, a radio process section 11, an audio process section 12, an audio input section 13, an audio output section 14, a data process section 15, an operation section (operating means) 16, a storage section 17, a main display section (display device) 18, a sub display section 19, a power supply section 20, and a control section (display control device) 21.

The antenna section 10 transmits outward a radiowave, and receives an external radiowave. Specifically, the antenna section 10 transmits and receives a radiowave for portable phones in the bandwidth of 800 MHz or 1.5 GHz.

The radio process section 11 obtains data from the audio process section 12 or the data process section 15, converts the data into a suitable form for wireless transmission, and then transmits outward, via the antenna section 10, a radio signal thus converted. Further, the radio process section 11 receives an external radio signal via the antenna section 10, converts the radio signal into an original format, and then transmits, to the audio process section 12 or the data process section 15, data thus converted. Specifically, a channel CODEC process, a baseband signal process, a data modulation/demodulation process, an RF (Radio Frequency) process, and the like are performed in the radio process section 11.

The audio process section 12 converts an audio signal supplied from the audio input section 13 into predetermined audio data, and then transmits the audio data to the radio process section 11. Further, the audio process section 12 converts audio data supplied from the radio process section 11 into an audio signal, and then transmits the audio signal to the audio output section 14. The audio process section 12 includes, concretely, an A/D converter, a D/A converter, an amplifier, and an audio CODEC circuit.

The audio input section 13 converts an externally-supplied sound wave into an audio signal that is an electric signal, and then transmits the audio signal to the audio process section 12. The audio input section 13 includes, concretely, a microphone.

The audio output section 14 converts the audio signal supplied from the audio process section 12 into a sound wave, and supplies outward the sound wave. The audio output section 14 includes, concretely, a speaker and an earphone. In the portable phone 1, normally, the earphone is utilized in making a conversation, and the speaker is utilized in notifying of an incoming call.

It is desirable in telephones that user-voice to be fed into the audio input section 13 be heard from the audio output section 14. It is thus preferable that the audio process section 12 adjust the audio signal supplied from the audio input section 13 so that the audio signal becomes a predetermined level of sound volume, and then transmit the audio signal thus adjusted to the audio output section 14.

The data process section 15 performs encoding on data supplied from the control section 21 so that the data becomes data in predetermined form, and then transmits the data in the predetermined form to the radio process section 11. Further, the data process section 15 decodes the data supplied from the radio process section 11, and then transmits the data thus decoded to the control section 21. Exemplary methods of data encoding/decoding (CODEC) performed in the data process section 15 include MPEG (Moving Picture Experts Group)—4 and ITU-T recommendation H.263.

The operation section 16 creates operation data and transmits the operation data to the control section 21, when a user operates an input device such as the main operation buttons 6 provided on a surface of the portable phone 1. An exemplary input device besides a button switch includes a touch panel. In the present embodiment, when a user operates a predetermined button, the operation section 16 creates operation data for giving an instruction to change the viewing angle, and transmits the operation data to the control section 21.

The storage section 17 stores various data and programs. Exemplary storage sections 17 include: a ROM (Read Only Memory) that is a read-only semiconductor memory for storing fixed data such as communication control data and a program necessary in operating the control section 21; and a RAM (Random Access Memory) that is so-called working memory, and temporarily stores data relating to bar-code recognition and communications, data to be used in calculation, results of calculation, and the like.

Each of the main display section 18 and the sub display section 19 obtains image data from the control section 21, and displays an image based on the image data thus obtained. Each of the main display section 18 and the sub display section 19 includes, concretely, a display element, such as a PDP (Plasma Display Panel), an LCD, and an EL (Electroluminescence) display, and a driver circuit to drive the display element in accordance with the image data thus obtained. The image includes pictures, figures, and characters. The image includes both still images and moving images.

In the present embodiment, the main display section 18 has the following function. Specifically, the main display section 18 obtains viewing-angle control data from the control section 21, and changes the viewing angle in accordance with the viewing-angle control data thus obtained. It is also possible that the sub display section 19 has the function to change the viewing angle.

The power supply section 20 supplies an adequate electric power to the configurations in the portable phone 1. The power supply section 20 is constituted of, for example, a rechargeable secondary battery, such as a lithium ion battery, and a power source circuit.

The control section 21 controls overall the configurations in the portable phone 1. The functions of the control section 21 are realized by a CPU (Central Processing Unit) executing a program stored in a storage unit such as an RAM or a flash memory.

FIG. 1 shows a schematic structure of the main display section 18 and the control section 21. As shown in the figure, the main display section 18 includes an image display section 50 and a viewing-angle changing section 51. As discussed above, the image display section 50 displays an image in accordance with image data supplied from the control section 21. The viewing-angle changing section 51 changes the viewing angle of the image display section 50.

The control section 21 includes an application executing section 40, a viewing-angle instruction obtaining section (viewing-angle information obtaining means) 41, a viewing-angle control section (viewing-angle controlling means) 42, a viewing-angle obtaining section (viewing-angle information obtaining means) 43, a viewing-angle display control section (viewing-angle information display controlling means) 44, and an image display control section 45.

The application executing section 40 executes various applications such as electronic-mail software and image browsing software. The application executing section 40 notifies the viewing-angle instruction obtaining section 41 of information on applications that are in execution.

When receiving the operation data that is supplied from the operation section 16 and gives an instruction to change the viewing angle, the viewing-angle instruction obtaining section 41 creates viewing-angle instruction data for changing the viewing-angle state. The viewing-angle instruction obtaining section 41 has information on viewing-angle states corresponding to predetermined applications. The viewing-angle instruction obtaining section 41 refers to the information on applications that are in execution, which information has been supplied from the application executing section 40, and, when a predetermined application is in execution, creates viewing-angle instruction data for specifying a viewing-angle state that corresponds to the predetermined application.

The viewing-angle instruction obtaining section 41 transmits the viewing-angle instruction data thus created to the viewing-angle control section 42 and the viewing-angle obtaining section 43. Besides the operation section 16 and the application executing section 40, the viewing-angle instruction obtaining section 41 can create the viewing-angle instruction data, which specifies the viewing-angle state, on the basis of information supplied from various devices and various blocks, and then transmit the data thus created to the viewing-angle control section 42 and the viewing-angle obtaining section 43.

The viewing-angle control section 42 controls the viewing-angle changing section 51 on the basis of the viewing-angle instruction data supplied from the viewing-angle instruction obtaining section 41. Specifically, when receiving the viewing-angle instruction data for changing the viewing-angle state, the viewing-angle control section 42 controls the viewing-angle changing section 51 to change the viewing-angle state. Further, the viewing-angle control section 42 retains the current viewing-angle state. When the viewing-angle state specified by the viewing-angle instruction data obtained is different from the current viewing-angle state, the viewing-angle control section 42 controls the viewing-angle changing section 51 to change the viewing-angle state to that specified by the viewing-angle instruction data. Further, the viewing-angle control section 42 transmits, to the viewing-angle obtaining section 43, viewing-angle state data that indicates the current viewing-angle state.

It is possible to indicate the viewing-angle state by indicating an actual value of the viewing angle or a level of the viewing angle, such as wide viewing-angle, narrow viewing-angle, and intermediate viewing-angle. In the present embodiment, a wide viewing-angle, which indicates that the viewing angle is wide, and a narrow viewing-angle, which indicates that the viewing angle is narrow, are employed to indicate the viewing-angle state.

The viewing-angle obtaining section 43 obtains the current viewing-angle state by receiving the viewing-angle state data from the viewing-angle control section 42. The viewing-angle obtaining section 43 is also able to predict the current viewing-angle state on the basis of the viewing-angle instruction data obtained from the viewing-angle instruction obtaining section 41. The viewing-angle obtaining section 43 transmits the viewing-angle data thus obtained, which data indicates the current viewing-angle state, to the viewing-angle display control section 44.

The viewing-angle display control section 44 controls, via the image display control section 45, the screen display section 50 on the basis of the viewing-angle data obtained from the viewing-angle obtaining section 43, thereby controlling a display of the viewing-angle state. Styles and conditions of the display of the viewing-angle state will be discussed below.

The image display control section 45 controls the image display section 50 on the basis of the image data obtained from various blocks in the control section 21 or various devices, thereby controlling a display on the main screen 4. As shown in FIG. 2 and elsewhere, not only the viewing-angle information 60 but also various images, such as an icon indicating a state of a battery, an icon indicating a state of a radiowave, and sentences of electronic mails, need to be displayed on the main screen 4. Therefore, the image display control section 45 combines various images by use a publicly-known superimposition technique, and controls the image display section 50 to display, on the main screen 4, the images thus combined. Accordingly, no special configuration of the image display section 50 is necessary to display the viewing-angle information 60 on the main screen 4.

The viewing-angle control section 42 retains the current viewing-angle state. This allows the viewing-angle obtaining section 43 to obtain the viewing-angle information only from the viewing-angle control section 42. In this case, it is possible to omit to obtain the viewing-angle information from the viewing-angle instruction obtaining section 41.

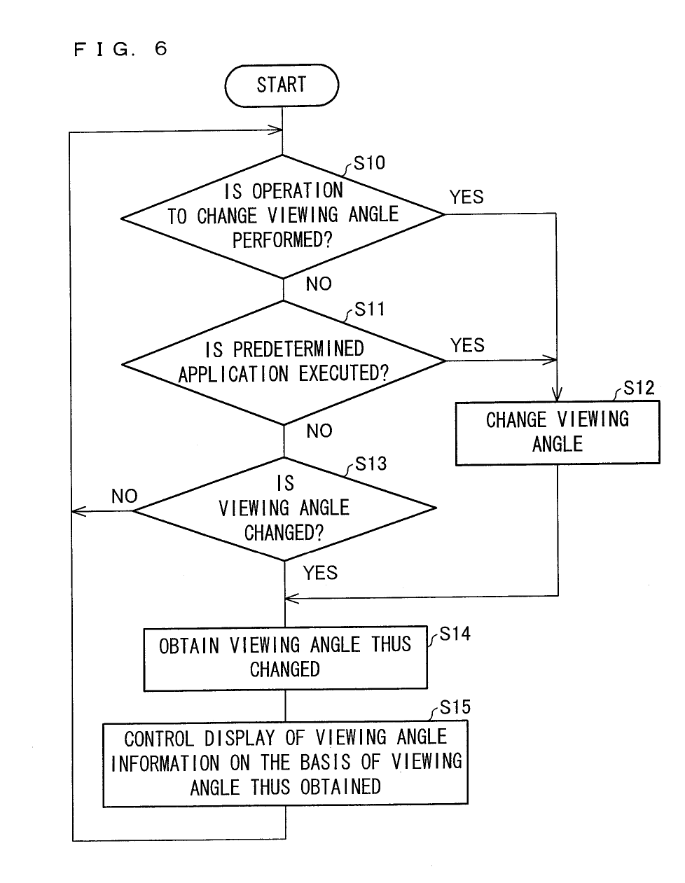

The following discusses operations to be performed in the portable phone 1 having the above configurations, with reference to FIG. 6. FIG. 6 shows operations to be performed by the control section 21 to control the main display section 18 to display the viewing-angle state.

As shown in FIG. 6, first of all, the viewing-angle instruction obtaining section 41 determines whether or not an operation to change the viewing angle is performed in the operation section 16 (step S10 (Hereinafter, the step is sometimes abbreviated as “S10”. This also applies to the other steps.)). If no operation is performed to change the viewing angle (NO in S10), then the viewing-angle instruction obtaining section 41 determines whether or not a predetermined application is in execution (S11).

If the operation to change the viewing angle is performed (YES in S10), or if the predetermined application is in execution (YES in S11), then the viewing-angle control section 42 controls the viewing-angle changing section 51 to change the viewing-angle state (S12). On the other hand, if no predetermined application is in execution (NO in S11), then the viewing-angle obtaining section 43 refers to the current viewing-angle state obtained from the viewing-angle control section 42, and determines whether or not the viewing angle is changed on the basis of other conditions (S13). If the viewing-angle state is not changed (NO in S13), then the flow of the operations moves back to the first step, S10, to repeat the above operations.

After the viewing-angle state is changed in step S12, or if the viewing-angle is changed in step S13 (YES in S13), the viewing-angle obtaining section 43 obtains the viewing-angle state thus changed (S14). On the basis of the viewing-angle state thus obtained, the viewing-angle display control section 44 controls a display of information on the viewing-angle state of the image display section 50 (S15). Thereafter, the flow of the operations moves back to the first step, S10, to repeat the above operations.

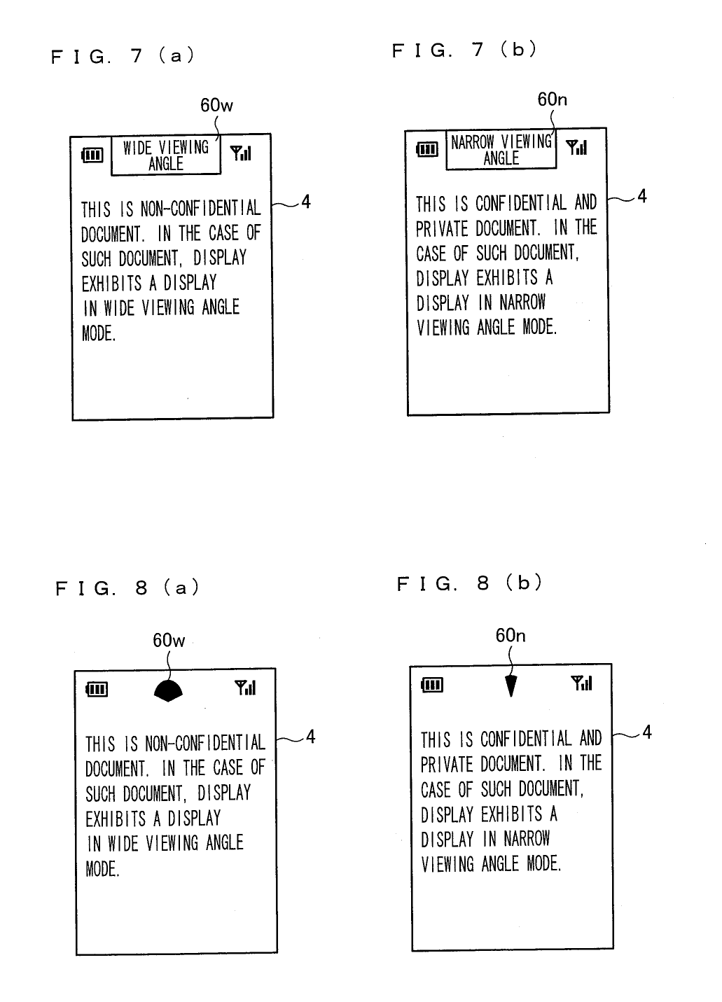

The following discusses exemplary viewing-angle information 60 to be displayed on the main display section 18, with reference to FIGS. 7 to 15. In FIGS. 7 to 12, each segment (a) of the respective figures shows a display on the display screen in the wide viewing-angle mode, and each segment (b) of the respective figures shows a display on the display screen in the narrow viewing-angle mode.

In FIGS. 7, 9, and 11, the viewing-angle information 60 is displayed by use of a series of characters, such as “wide viewing-angle” and “narrow viewing-angle.” In FIGS. 8, 10, and 12, the viewing-angle information 60 is displayed by use of an icon, that is, a wide sector and a narrow sector. As the foregoing discusses, it is possible to display the viewing-angle information 60 in various display styles, such as a series of characters and an icon. It is preferable that, especially, the viewing-angle information 60 be displayed in easily and promptly recognizable style for the user.

Further, in FIGS. 7 and 8, viewing-angle information 60w of wide viewing angle is displayed during the wide viewing-angle mode, and viewing-angle information 60n of narrow viewing angle is displayed during the narrow viewing-angle mode. This allows the user to easily find out whether the current viewing-angle state is the wide viewing-angle mode or the narrow viewing-angle mode by simply looking at the display on the display screen.

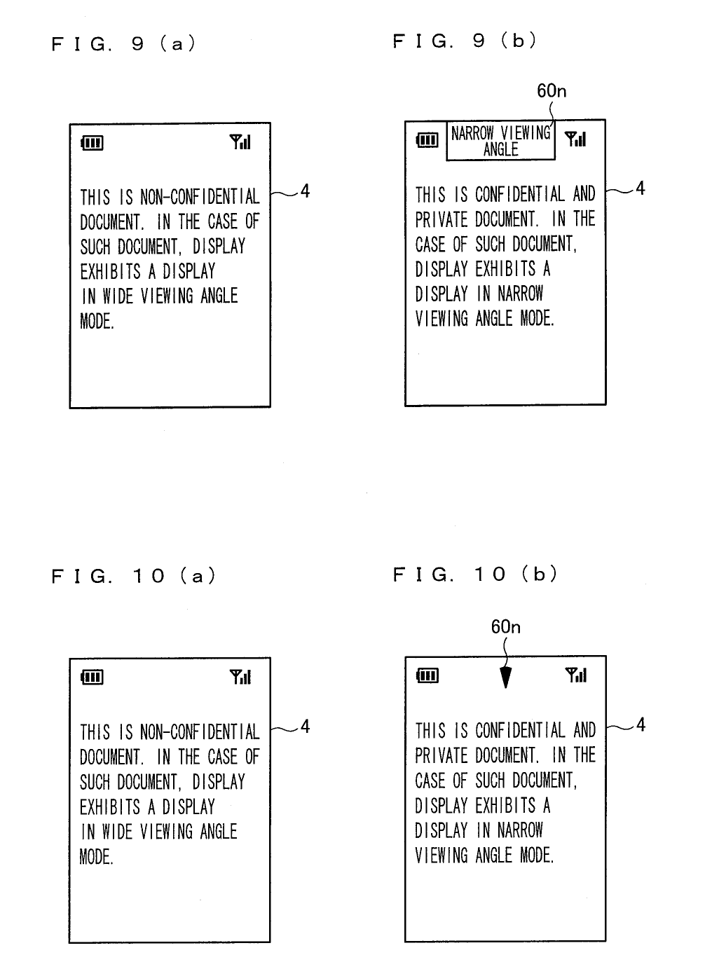

Further, in FIGS. 9 and 10, no viewing-angle information 60 is displayed during the wide viewing-angle mode, and the viewing-angle information 60n of narrow viewing angle is displayed during the narrow viewing-angle mode. In this case, the user can easily find out that the current viewing-angle state is in the wide viewing-angle mode by seeing no viewing-angle information 60 on the display screen. Further, for example in a case where the wide viewing-angle mode is a normal viewing-angle mode, and the narrow viewing-angle mode is a special viewing-angle mode for an event of creating mails and the like, displaying the viewing-angle information 60n only during the narrow viewing-angle mode allows the user to recognize that it is the special viewing-angle mode. This gives ease to the user in conducting a process such as creating mails.

On the contrary, in FIGS. 11 and 12, the viewing-angle information 60w of wide viewing-angle is displayed during the wide viewing-angle mode, and no viewing-angle information 60 is displayed during the narrow viewing-angle mode. In this case, the user can easily find out that the current viewing-angle state is the narrow viewing-angle mode by seeing no viewing-angle information 60 displayed on the display screen. Further, for example in the case where the wide viewing-angle mode is the normal viewing-angle mode, and the narrow viewing-angle mode is the special viewing-angle mode for the event of creating mails and the like, displaying the viewing-angle information 60w only during the wide viewing-angle mode allows the user to recognize that it is not the special viewing-angle mode and to receive this as a warning message in conducting a process such as creating mails. Therefore, in this case, it is preferable that the viewing-angle information 60w be displayed in flash or in red-color.

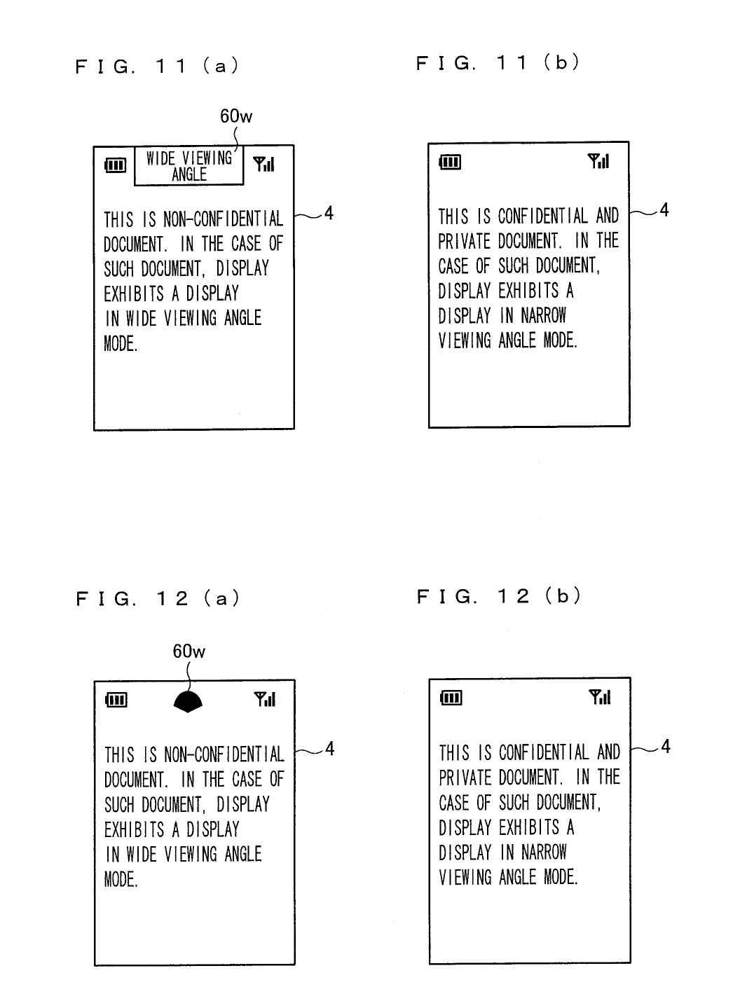

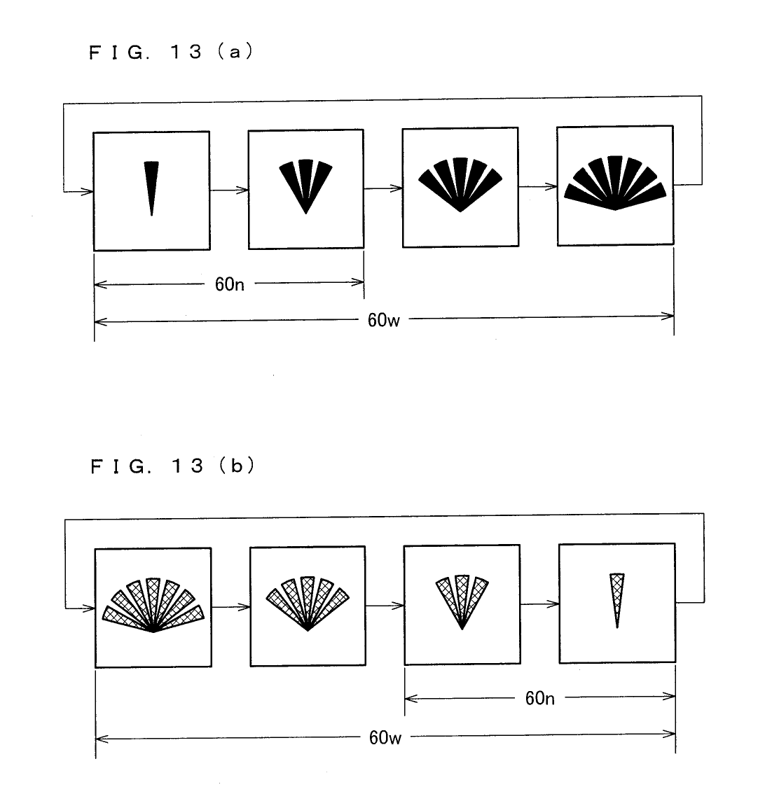

FIGS. 13(a) and 13(b) each show a state in which the viewing-angle information 60 is displayed by use of an icon of a moving image. This figure (a) shows that the moving image is displayed in a manner such that a sector gradually opens. This figure (b) shows that the moving image is displayed in a manner such that a sector gradually closes. In this case, two diagrams on the left in figure (a) or two diagrams on the right in figure (b) are used as the viewing-angle information 60n of narrow viewing angle during the narrow viewing-angle mode, and all of four diagrams in figure (a) or all of four diagrams in figure (b) are used as the viewing-angle information 60w of wide viewing angle during the wide viewing-angle mode.

As the foregoing discusses, the viewing-angle information 60 can be displayed by use of a moving image. In this case, it is possible to draw the user's attention to the viewing-angle information 60, compared with the case in which the viewing-angle information 60 is displayed by use of a still image. To be responsive to a case in which the display using the moving image causes the user to feel disturbed, it is preferable that the display using the moving image as shown in FIG. 13 and the display using the still image as shown in FIG. 8 be allowed to be switched by operations with the operation section 16 or by setting of display.

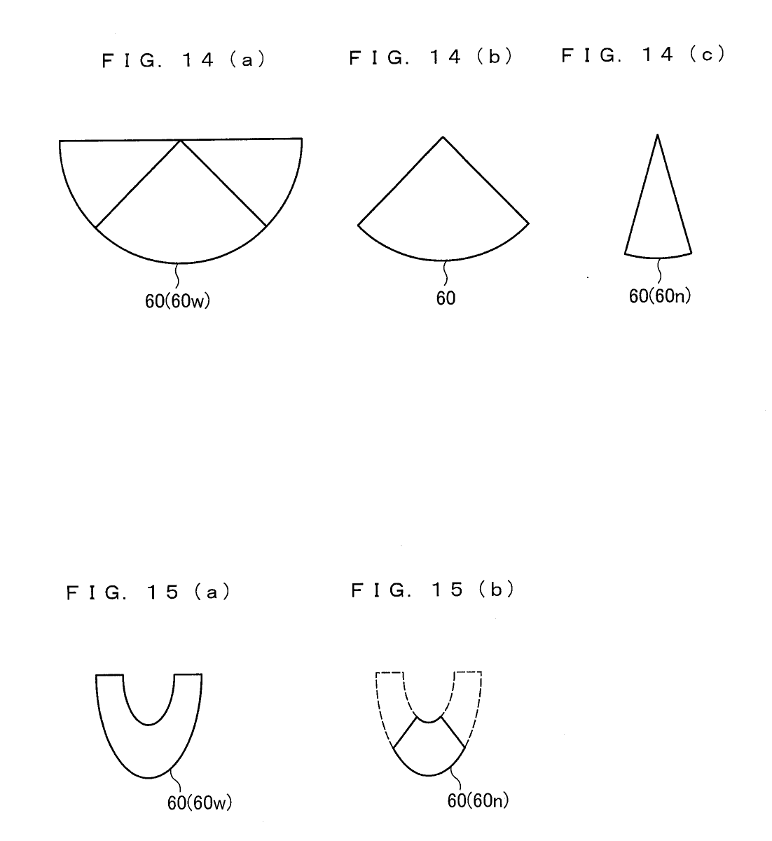

FIGS. 14(a) to 14(c) each show another icon as exemplary viewing-angle information 60. The icon is a sector-icon, which is shown in FIG. 8 or elsewhere, displayed upside down. More particularly, while each of the sector-icons shown in FIG. 8 and elsewhere is formed in a manner such that its lower section is a core and its upper section is wide, each of the sector-icons shown in FIGS. 14(a) to 14(c) is formed in a manner such that its upper section is a core and its lower section is wide. In this case, the user can intuitively find out how far the user needs to move sideward from the front of the main screen 4 for the display screen to become invisible.

FIG. 14(a) shows an icon 60w of the wide viewing-angle mode. FIG. 14(c) shows an icon 60n of the narrow viewing-angle mode. FIG. 14(b) shows an icon 60 of an intermediate viewing-angle mode in which the viewing angle is neither wide nor narrow. This viewing-angle mode is suitable for the case in which the display screen is seen by two to three people including the user. As the foregoing discusses, it is possible to set a mode of at least three viewing angles or a mode of continuous viewing angles, depending on the number of viewing angles that the viewing-angle changing section 51 is allowed to set.

FIGS. 15(a) and 15(b) each show another icon as exemplary viewing-angle information 60. An icon 60 shown in the figures is U-shaped. FIG. 15(a) shows an icon 60w of the wide viewing-angle mode. FIG. 15(b) shows an icon 60n of the narrow viewing-angle mode. The icon 60w of the wide viewing-angle mode is displayed in a manner such that a whole U-shape is displayed. The icon 60n of the narrow viewing-angle mode is displayed in a manner such that only a central section of the U-shape is displayed. As the foregoing discusses, it is possible to employ an icon whose length changes depending upon the viewing angle, as shown in FIG. 15, in place of the sector-icon whose angle changes depending upon the viewing angle, as shown in FIG. 8 or elsewhere. Although the icon in U-shape is employed in the case shown in the figures, it is also possible to employ an icon in rectangular-shape whose top and bottom sides are longer than the other two sides.

As the foregoing discusses, as long as the user can easily find out the level of the viewing angle, it is possible to employ any symbols including characters and figures, and further, to freely select a dimension, a shape, a color, and the like of the symbols.

The present invention is not limited to the description of the embodiments above, but may be altered by a skilled person within the scope of the claims. An embodiment based on a proper combination of technical means disclosed in different embodiments is encompassed in the technical scope of the present invention.

For example, the above embodiment discusses the case in which the present invention is applied to the portable phone 1. However, the present invention is not limited to the case. The present invention is applicable to any portable electronics devices, such as PHS (Personal Handy-phone System), PDA, mobile PC (Personal Computer), and portable DVD (Digital Versatile Disk), as long as the portable electronics devices include a display apparatus having the function of controlling the viewing angle. The present invention is also applicable to stationary displays.

Further, although the viewing-angle information 60 is displayed at a central section of an upper end of the display screen 4 in FIGS. 7 to 12, it is also possible to display the viewing-angle information 60 at a lower end section or a corner section of the display screen 4. Furthermore, it is also possible to display the viewing-angle information 60 at a central part of the display screen in a manner such that the viewing-angle information 60 and other images are superposed. As the foregoing discusses, it is possible to display the viewing-angle information 60 at any place on the display screen 4.

Further, in the above embodiment, discontinuous viewing-angle information is displayed, such as the wide viewing-angle or the narrow viewing-angle. In the case where a display device that allows the viewing angle to be changed in a continuous manner is employed, it is possible to display continuous viewing-angle information. Specifically, the viewing angle itself is displayed, or a sector-icon is displayed in a manner such that an angle of the icon is changed continuously.

Further, it is possible for the respective blocks, especially the control section 21, in the portable phone 1 to be configured on the basis of hardware logic, or to be realized with software by using a CPU as discussed below.

Specifically, the portable phone 1 includes: a CPU for executing an instruction of a control program for realizing respective functions; a ROM for storing the program; a RAM for developing the program; and a storage unit (a storage medium), such as a memory, for storing the program and various data. The object of the present invention is also achieved by (i) supplying, to the portable phone 1, a computer-readable storage medium storing a program code (execute form program, intermediate code program, source program) of a control program of the portable phone 1, which control program is software for realizing the functions discussed above, and (ii) causing a computer (or CPU or MPU) to read out and carry out the program code stored in the storage medium.

Exemplary storage medium that may be used as the storage medium discussed above include: tapes such as a magnetic tape and a cassette tape; disks such as an magnetic disk (e.g., flexible disk, hard disk) and an optical disk (e.g., CD-ROM, MO, MD, DVD, CD-R); cards such as an IC card (including memory card) and an optical card; and semiconductor memories such as a mask ROM, an EPROM, an EEPROM, and a flash ROM.

Further, it is also possible to make an arrangement that the portable phone 1 is allowed to be connected to a communication network, and the program code is supplied via the communication network. The communication network is not particularly limited, and the followings may be used as the communication network, for example: the Internet, intranet, extranet, LAN, ISDN, VAN, CATV communication network, virtual private network, telephone line network, mobile communication network, and satellite communication network. Further, transmission medium that configure the communication network is not particularly limited, and the followings may be used, for example: a wire transmission medium, such as IEEE 1394, USB, power-line carrier, cable TV circuit, telephone line, ADSL circuit, and wireless such as infrared ray (e.g., IrDA, remote-controller), Bluetooth (registered trademark), wireless 802.11, HDR, mobile telephone network, satellite circuit, and terrestrial digital network. The present invention is also realized in the form of a carrier or data signal sequence that is realized by electrical transmission of the program code.

A display control device according to the present invention, controlling a display on a display device with a viewing angle that is variable, may include: viewing-angle information obtaining means for obtaining viewing-angle information relating to the viewing angle of the display device; and viewing-angle information display controlling means for controlling the display device to display the viewing-angle information obtained by the viewing-angle information obtaining means.

The viewing-angle information may be an actual value of the viewing angle, or information indicating a level of the viewing angle, e.g. the viewing angle is wide or narrow. Further, it is possible to select any display style in displaying the viewing-angle information, including: displaying by use of a series of characters; displaying by use of an icon; displaying at an upper end section, a lower end section, or a corner section of the display screen; displaying at a central section of the display screen in such a way as to superimpose with other images; and displaying by use of a moving image.

In the above configuration, the viewing-angle information relating to the display device, which information is obtained by the viewing-angle information obtaining means, is displayed on the display device as a result of controlling by the viewing-angle information display controlling means. This allows a user to find out the viewing-angle state by looking at the display screen of the display device from the front. This gives ease to the user in conducting a process relating to privacy, such as creating and seeing an electronic mail. Further, the user no longer needs to move himself/herself or tilt the display screen in order to find out the viewing-angle state.

In the display control device according to the present invention, the viewing-angle information display controlling means may control the display device so that the viewing-angle information is displayed when the viewing-angle information is in predetermined condition, and the viewing-angle information is not displayed when the viewing-angle information is in condition other than the predetermined condition. In this case, the user can know that the viewing-angle information is not in the predetermined condition by seeing no display of the viewing-angle information, and find out a viewing-angle state. For example in the case where the display device is switchable between a wide viewing-angle mode and a narrow viewing-angle mode, the viewing-angle information display controlling means may control the display device so that the viewing-angle information is displayed in one of the wide viewing-angle mode and the narrow viewing-angle mode, and is not displayed in the other one of the wide viewing-angle mode and the narrow viewing-angle mode.

It is preferable that the display control device according to the present invention further include viewing-angle controlling means for controlling the viewing angle of the display device, and that the viewing-angle information obtaining means obtain the viewing-angle information from the viewing-angle controlling means. In this case, current viewing-angle information is accurately obtained from the viewing-angle controlling means, and therefore current viewing-angle information is accurately displayed on the display device.

In the display control device according to the present invention, the viewing-angle controlling means may control the viewing angle in such a way as to link with execution of an application program, and the viewing-angle information obtaining means may obtain the viewing-angle information from an application program that is in execution.

The display control device according to the present invention may further include operating means for accepting operation performed by a user, and the viewing-angle information obtaining means may obtain the viewing-angle information from a viewing-angle change instruction that the operating means accepts.

In the display control device according to the present invention, the viewing-angle information display controlling means may control the display device so that the viewing-angle information is displayed by use of a series of characters. Further, in the display control device according to the present invention, the viewing-angle information display controlling means may control the display device so that the viewing-angle information is displayed by use of an icon. Especially in the case where the viewing-angle information is displayed by use of an icon, it is preferable that the viewing-angle information be expressed by changing a display style of the icon, for example changing a shape of the icon and changing a color of the icon.

Further, a display apparatus including a display device with a viewing angle that is variable and the display control device having the above configuration and controlling the display of the display device also produces the above advantageous effects. It is effective especially for portable display apparatuses.

A method according to the present invention for controlling a display on a display device with a viewing angle that is variable may include the steps of: obtaining viewing-angle information relating to the viewing angle of the display device; and controlling the display device to display the viewing-angle information.

In the above method, controlling is performed so that the viewing-angle information of the display device, which information is obtained in the viewing-angle information obtaining step, is displayed on the display device in the viewing-angle information display control step. This allows a user to find out the viewing-angle state by looking at the display screen of the display device from the front. This gives ease to the user in conducting a process relating to privacy, such as creating and seeing an electronic mail. Further, the user no longer needs to move himself/herself or tilt the display screen in order to find out the viewing-angle state.

The viewing-angle information obtaining means and the viewing-angle information display controlling means in the display control device are executable on a computer by use of a display control program. Further, the display control program is executable on any computers by storing the display control program in a computer-readable storage medium.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

A display control device according to the present invention allows viewing-angle information of a display device to be displayed on the display device. Therefore, the display control device according to the present invention is applicable to not only portable display apparatuses but also any display apparatuses having a function of controlling the viewing angle.

1: A display control device, controlling a display on a display device with a viewing angle that is variable,
the display control device comprising:
viewing-angle information obtaining means for obtaining viewing-angle information relating to the viewing angle of the display device; and
viewing-angle information display controlling means for controlling the display device to display the viewing-angle information obtained by the viewing-angle information obtaining means.

2: The display control device according to claim 1, wherein the viewing-angle information display controlling means controls the display device so that the viewing-angle information is displayed when the viewing-angle information is in predetermined condition, and the viewing-angle information is not displayed when the viewing-angle information is in condition other than the predetermined condition.

3: The display control device according to claim 2, wherein:
the display device is switchable between a wide viewing-angle mode and a narrow viewing-angle mode; and
the viewing-angle information display controlling means controls the display device so that the viewing-angle information is displayed in one of the wide viewing-angle mode and the narrow viewing-angle mode, and is not displayed in other one of the wide viewing-angle mode and the narrow viewing-angle mode.

4: The display control device according to claim 1, further comprising:
viewing-angle controlling means for controlling the viewing angle of the display device,
the viewing-angle information obtaining means obtaining the viewing-angle information from the viewing-angle controlling means.

5. The display control device according to claim 4, wherein:
the viewing-angle controlling means controls the viewing angle in such a way as to link with execution of an application program; and
the viewing-angle information obtaining means obtains the viewing-angle information from an application program that is in execution.

6: The display control device according to claim 1, further comprising:
operating means for accepting operation performed by a user,
the viewing-angle information obtaining means obtaining the viewing-angle information from a viewing-angle change instruction that the operating means accepts.

7: The display control device according to claim 1, wherein the viewing-angle information display controlling means controls the display device so that the viewing-angle information is displayed by use of a series of characters.

8: The display control device according to claim 1, wherein the viewing-angle information display controlling means controls the display device so that the viewing-angle information is displayed by use of an icon.

9: The display control device according to claim 8, wherein the viewing-angle information display controlling means expresses the viewing-angle information by controlling the display device to change a display style of the icon.

10: A display apparatus, comprising:
a display device with a viewing angle that is variable; and a display control device defined in claim 1 to control a display on the display device.

11: The display apparatus according to claim 10, wherein the display apparatus is portable.

12: A method for controlling a display on a display device with a viewing angle that is variable,
the method comprising the steps of:
obtaining viewing-angle information relating to the viewing angle of the display device; and
controlling the display device to display the viewing-angle information.

13: A display control program for causing a display control device defined in claim 1 to operate, the display control program causing a computer to function as viewing-angle information obtaining means and viewing-angle information display controlling means.

14: A computer-readable storage medium storing the display control program defined in claim 13.
